(19) United States
(12) Patent Application Publication
(10) Pub. No.: US 2024/0404099 A1
(43) Pub. Date: Dec. 5, 2024

(54) Estimating Device Pose Using Plane Normal Vectors

(71) Applicant: Apple Inc., Cupertino, CA (US)

(72) Inventors: Seongdo Kim, Campbell, CA (US); Oliver T. Ruepp, Baierbrunn, CA (US)

(21) Appl. No.: 18/677,443

(22) Filed: May 29, 2024

Related U.S. Application Data
(60) Provisional application No. 63/470,716, filed on Jun. 2, 2023.

(51) Int. Cl. G06T 7/70; G06T 5/40; G06T 7/50

(52) U.S. Cl. CPC G06T 7/70; G06T 5/40; G06T 7/50

(57) ABSTRACT

A method includes obtaining image data corresponding to a physical environment from an image sensor in an electronic device. The electronic device may determine surface normal frequency data based on the image data. The electronic device may determine an orientation of the electronic device in the physical environment based on the surface normal frequency data.

### CROSS-REFERENCE TO RELATED APPLICATION

This application claims the benefit of U.S. Provisional Patent App. No. 63/470,716, filed on Jun. 2, 2023, which is incorporated by reference in its entirety.

### TECHNICAL FIELD

The present disclosure relates to estimating device pose using image data.

### BACKGROUND

Devices such as cameras may use pose information to facilitate certain functionalities, such as object tracking, motion estimation, and scene understanding. By knowing the position and orientation of a camera, a system can determine the location of an object in three-dimensional (3D) space, measure its size, and estimate its motion. In computer-generated reality (CGR) applications, pose information may enable the proper alignment of virtual objects with a physical environment. By tracking the motion of a camera, a system may overlay computer-generated content on the camera view, creating an immersive and interactive experience.

### SUMMARY

Various implementations disclosed herein include devices, systems, and methods for estimating the pose of an electronic device using plane normal vectors. In various implementations, a device includes an image sensor, a non-transitory memory and one or more processors coupled with the image sensor and the non-transitory memory. In accordance with some implementations, a method is performed at an electronic device with one or more processors and a non-transitory memory. The method includes method obtaining image data corresponding to a physical environment from an image sensor in an electronic device. The electronic device may determine surface normal frequency data based on the image data. The electronic device may determine an orientation of the electronic device in the physical environment based on the surface normal frequency data.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1A is a diagram of an example operating environment in accordance with some implementations.

FIGS. 1B-1J are diagrams of images that may be used to determine a pose of an electronic device based on normal vector information in accordance with some implementations.

FIG. 2 is a block diagram of an orientation system in accordance with some implementations.

FIG. 3 is a flowchart representation of a method of determining a pose of an electronic device based on normal vector information in accordance with some implementations.

FIG. 4 is a block diagram of a device that determines a pose of an electronic device based on normal vector information in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/of” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

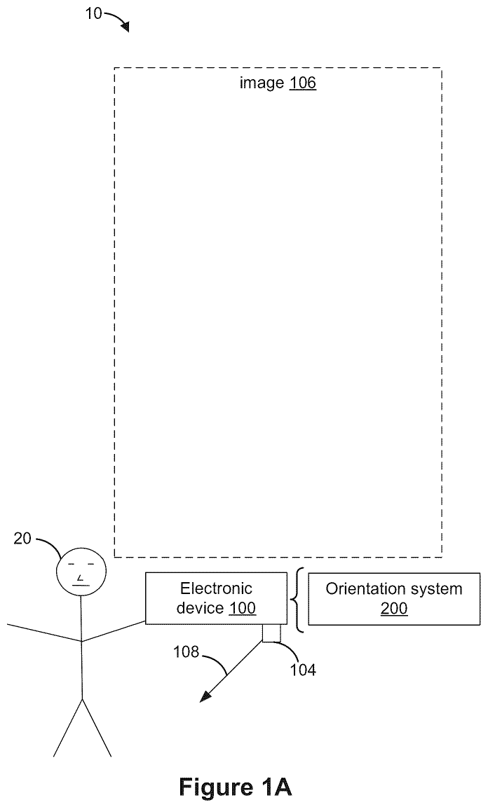

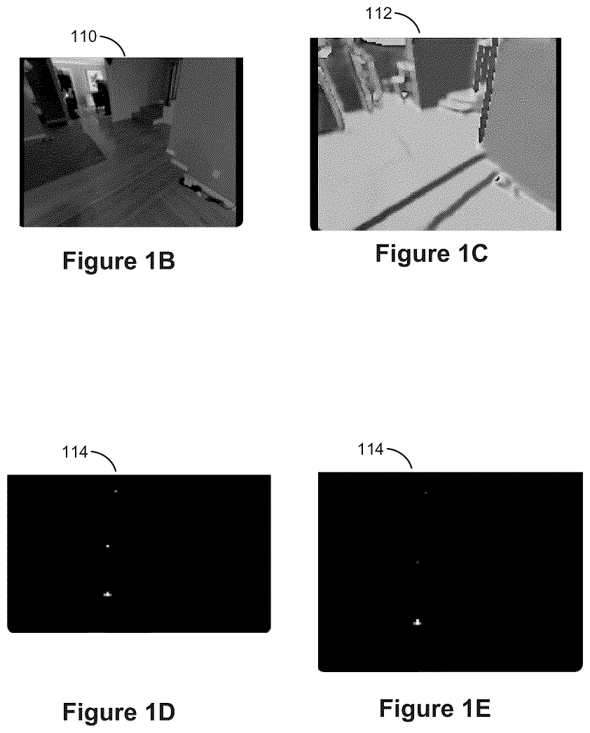

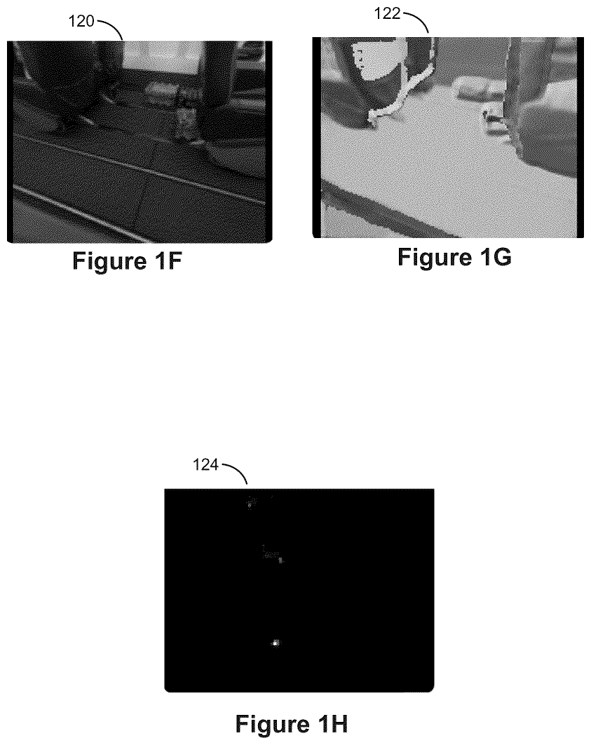

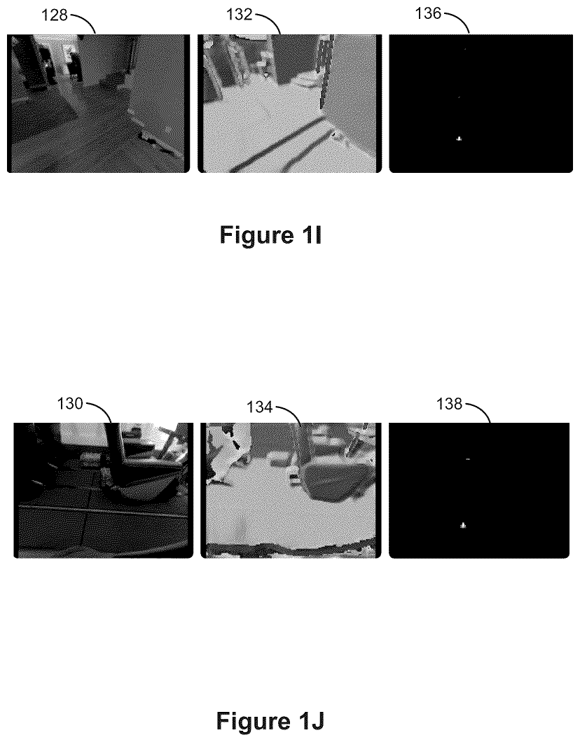

FIG. 1A is a block diagram of an example operating environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 10 includes an electronic device 100 and an orientation system 200. In some implementations, the electronic device 100 includes a handheld computing device that can be held by a user 20. For example, in some implementations, the electronic device 100 includes a smartphone, a tablet, a media player, a laptop, or the like. In some implementations, the electronic device 100 includes a wearable computing device that can be worn by the user 20. For example, in some implementations, the electronic device 100 includes a head-mountable device (HMD) or an electronic watch.

In the example of FIG. 1A, the orientation system 200 resides at the electronic device 100. For example, the electronic device 100 may implement the orientation system 200. In some implementations, the electronic device 100 includes a set of computer-readable instructions corresponding to the orientation system 200. Although the orientation system 200 is shown as being integrated into the electronic device 100, in some implementations, the orientation system 200 is separate from the electronic device 100. For example, in some implementations, the orientation system 200 resides at another device (e.g., at another electronic device, a controller, a server or a cloud computing platform).

As illustrated in FIG. 1A, in some implementations, the electronic device 100 includes an image sensor 104 that captures an image 106 that corresponds to (e.g., includes) a field of view of the user 20. The image 106 may be converted to image data 108. In some implementations, the image data 108 represents a still image. In some implementations, the image data 108 represents a frame of a video stream captured by the image sensor 104. In some implementations, the image data represents two or more video frames of a video stream.

In some implementations, analyzed surface normal vectors may be computed based on dense normal estimation of a frame. For example, the image data may be analyzed to generate a histogram characterizing relative frequencies of normal vectors. Analyzing the surface normal vectors may facilitate estimating real-time relative camera rotation, as well as performing real-time deterministic surface detection.

FIG. 1B illustrates an example image 110 that may be captured by the image sensor 104. FIG. 1C illustrates an example image 112 with per pixel normal vectors corresponding to the image 110 extracted. As shown in FIG. 1C, in some implementations, the distribution of surface normal vectors may demonstrate relative maximums, e.g., peaks, at certain locations. For example, if the ground is visible in the image 112, a vector normal to the ground may be expected to fall within one of the normal distribution peaks.

In some implementations, a transformation to a spherical coordinate system may be employed. FIG. 1D illustrates an example normal vector distribution 114 in a spherical coordinate system. FIG. 1E illustrates the vector distribution 114 with certain relative maximums indicated. For example, some normal vectors may be normal to a vertical plane. Another normal vector may be normal to the ground.

In some implementations, the normal frequency data may be determined by creating a histogram. For example, FIG. 1F illustrates an example image 120 that may be captured by the image sensor 104. As shown in FIG. 1F, the image 120 may be characterized by several curved surfaces. FIG. 1G illustrates an example image 122 with per pixel normal vectors corresponding to the image 120 extracted. As shown in FIG. 1G, in some implementations, the distribution of surface normal vectors may demonstrate relative maximums, e.g., peaks, at certain locations. For example, if the ground is visible in the image 122, a vector normal to the ground may be expected to fall within one of the normal distribution peaks.

A two-dimensional (2D) histogram may be created in spherical coordinates using a spherical coordinate transformation, e.g.,

$$\begin{matrix}θ = {cos}^{- 1} \frac{z}{\sqrt{{x}^{2} + {y}^{2} + {z}^{2}}} \\ ϕ = sgn ( y ) \cdot {cos}^{- 1} \frac{x}{\sqrt{{x}^{2} + {y}^{2}}}\end{matrix}$$

to transform unit vectors to an embedding space. In the embedded space, some features may become apparent. For example, even in an environment characterized by curvatures, dominant orientations may be visible. FIG. 1H illustrates an example 2D histogram 124 in spherical coordinates with relative maximums indicated. FIGS. 1I and 1J illustrate additional examples of images 128, 130; corresponding normal analyses 132, 134; and normal histograms 136, 138. Relative maximums in the embedded spaces may be aligned with surface orientations of major structures in the images 128, 130. Relative maximums in the normal histograms 136, 138 may be selected as tentative surface orientations. In some implementations, the video data may represent overlapping or successive video frames in a video stream, and the relative maximums and/or the distributions around the relative maximums may serve as landmarks to compute relative rotation of the electronic device between the frames. In some implementations, camera axis estimation in this way does not rely on external sensory data, such as from an inertial measurement unit (IMU). Accordingly, results of this approach to camera axis estimation may be accurate even if simultaneous localization and mapping (SLAM) fails to track the camera pose.

In some implementations, the orientation of a set of axes corresponding to an electronic device may be estimated. For example, a set of mutually orthogonal normal vectors {n₁, n₂, n₃} may be selected based on the relative maximums. A Gram-Schmidt process may be applied to the vectors to orthonormalize the vectors. The normal vectors may then form a rotation matrix, R=[n₁ n₂ n₃]. The rotation may be adjusted (e.g., optimized) by adjusting (e.g., minimizing) the cost function

$$c = arg {min}_{R} {\sum }_{∀ {n}_{i}} δ ( {n}_{i} ) ,$$

where δ(nᵢ) refers to a geodesic distance to the nearest peak in a spherical space. In some implementations, other cost functions may be used, such as the cost function

$$c = arg {min}_{R} {\sum }_{∀ {l}_{j}} γ ( {min}_{{n}_{i}} ( 1 - \vert {l}_{j} \cdot {n}_{i} \vert ) ) ,$$

where γ(·) may refer to a threshold robust cost function, e.g., a threshold Cauchy function, and lⱼ represents a normalized line vector, which may be potentially be pre-filtered. Other entities, such as line segments, may be substituted to compute the cost function. In some implementations, normal analysis provides axes candidate models in a robust way.

In various implementations, the electronic device 100 (e.g., the orientation system 200) uses a plane estimation algorithm to further filter candidate normal vectors for determining an orientation of the electronic device 100. Using a plane estimation algorithm may improve confidence in the normal vectors. If planes can be used, one matched plane between two frames in the image data is sufficient to determine relative rotation between the frames. Depending on the number of plane orientations, motion of the electronic device 100 in one or more axes may be determined.

In some implementations, dense normal vectors may be calculated using a normal estimation algorithm. Spherical coordinates may be computed from each normal vector, and the spherical coordinates may be mapped to an angle histogram. Using relative maximums (e.g., peaks) in the angle histogram as models, pixels may be clustered without suppressing non-maximums. Neighbor bins may be different up to a degree determined by the number of bins, e.g., in zenith and azimuth directions. In some implementations, after calculating plane segments, normal vectors may be recomputed from each plane segment. If neighbor bins share the same property, the averaged normal vectors may become closer than the original normal vectors.

In some implementations, a dense three-dimensional (3D) point cloud in the camera coordinate system may be computed using a depth map. For example, pixels in the image data may be mapped to the distance space. The mapping may be computed by the dot product of a 3D point at a pixel i with its belonging cluster j's normal vector nⱼ: dᵢ=nⱼ·pᵢ. In some implementations, the 3D point cloud may be used to determine planes in the plane estimation algorithm disclosed herein. The determined planes may be used to recover one or more components of relative camera position. Relative camera position may be characterized by three degrees of freedom, e.g., along the x, y, and z axes. Depending on the orientations of matched planes, one or more of these components may be estimated.

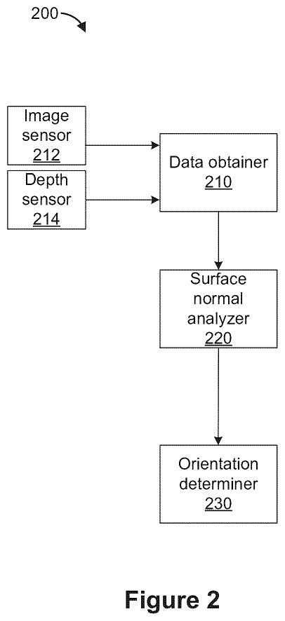

FIG. 2 is a block diagram of an orientation system 200 for determining a pose of an electronic device based on normal vector information in accordance with some implementations. In various implementations, the orientation system 200 includes some or all of the components of the electronic device 100 in FIG. 1A. In some implementations, the orientation system 200 includes a peripherals interface, one or more CPU(s), and/or a memory controller for processing and storage resources.

In various implementations, the orientation system 200 or portions thereof are included in a device (e.g., the electronic device 100) enabled with an image sensor 212 to obtain an image of a physical environment in which the electronic device 100 is located. A data obtainer 210 may be configured to obtain image data corresponding to the physical environment from the image sensor 212. For example, the electronic device may be or may incorporate a camera having an image sensor. In some implementations, the image data may represent a still image. The image data may represent a video frame from a video stream. In some implementations, the image data may represent a plurality of video frames from a video stream. The video frames may include, for example, a first video frame and a second video frame. The image data may include data corresponding to pixels of an image representing the physical environment. Image analysis may be performed on the image data to identify surfaces in the image and, in turn, surface normal vectors corresponding to the surfaces. In addition to obtaining the image data, the data obtainer 210 may obtain depth information from a depth sensor 214. The depth information may include a depth map.

In various implementations, a surface normal analyzer 220 may determine surface normal frequency data based on the image data. For example, the image data may be analyzed to generate a histogram characterizing relative frequencies of normal vectors. Analyzing the surface normal vectors may facilitate estimating real-time relative camera rotation, as well as performing real-time deterministic surface detection. In some implementations, the surface normal analyzer 220 may identify at least one relative maximum based on the surface normal frequency data. In some implementations, the surface normal analyzer 220 may identify at least one relative maximum based on depth information obtained from the depth sensor 214.

In some implementations, an orientation determiner 230 determines an orientation of the electronic device in the physical environment based on the surface normal frequency data. For example, in some implementations, the orientation determiner 230 may determine a set of mutually orthogonal vectors that correspond to the electronic device based on the at least one relative maximum. The vectors may be normalized so that the vectors are unit vectors, e.g., with a length of one unit.

In various implementations, the orientation determiner 230 determines an orientation of the electronic device in the physical environment based on the surface normal frequency data. For example, in some implementations, the orientation determiner 230 may identify a plane that is represented in the image data based on the surface normal frequency data. If the surface normal frequency data indicates that a region of the image represented by the image data corresponds to surface normal vectors that are aligned, for example, it may be inferred that a plane exists in the region and that the plane has a normal vector that is parallel to the surface normal vectors.

In some implementations, the orientation determiner 230 may identify a plane that is represented in a plurality of video frames that are represented in the image data. The orientation determiner 230 may determine the relative motion of the electronic device based on the identified plane represented in the plurality of video frames. For example, a change in the apparent position of the identified plane between a first video frame and a second video frame may be used to infer the motion of the electronic device.

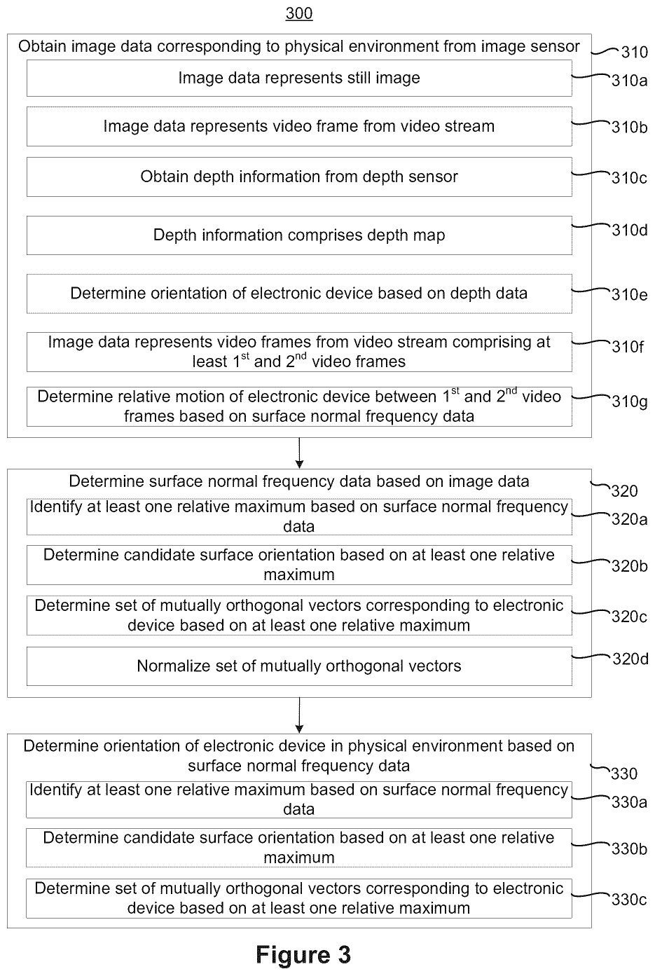

FIG. 3 is a flowchart representation of an example method 300 of determining a pose of an electronic device based on normal vector information, in accordance with some implementations. In various implementations, the method 300 is performed by a device (e.g., the electronic device 100 shown in FIG. 1A, or the orientation system 200 shown in FIGS. 1A and 2). In some implementations, the method 300 is performed by processing logic, including hardware, firmware, software, or a combination thereof. In some implementations, the method 300 is performed by a processor executing code stored in a non-transitory computer-readable medium (e.g., a memory). In various implementations, a CGR environment corresponding to a field of view of an image sensor (e.g., a scene-facing camera) of the device is displayed.

The method 300 can include obtaining image data that corresponds to a physical environment from an image sensor. Surface normal frequency data may be determined based on the image data. An orientation of the electronic device in the physical environment may be determined based on the surface normal frequency data.

In various implementations, as represented by block 310, the method 300 includes obtaining image data corresponding to a physical environment from an image sensor. For example, the electronic device may be or may incorporate a camera having an image sensor. For example, FIG. 1B illustrates an example image 110 that may be captured by the image sensor. As represented by block 310a, in some implementations, the image data may represent a still image. In some implementations, as represented by block 310b, the image data may represent a video frame from a video stream. The image data may include data corresponding to pixels of an image representing the physical environment. Image analysis may be performed on the image data to identify surfaces in the image and, in turn, surface normal vectors corresponding to the surfaces. FIG. 1C illustrates an example image 112 with per pixel normal vectors corresponding to the image 110 of FIG. 1B extracted. As shown in FIG. 1C, in some implementations, the distribution of surface normal vectors may demonstrate relative maximums, e.g., peaks, at certain locations. For example, if the ground is visible in the image 112, a vector normal to the ground may be expected to fall within one of the normal distribution peaks.

In addition to obtaining the image data, as represented by block 310c, the method 300 may include obtaining depth information from a depth sensor. As represented by block 310d, the depth information may include a depth map. In some implementations, as represented by block 310e, an orientation of the electronic device may be determined based in part on the depth data.

In some implementations, as represented by block 310f, the image data may represent a plurality of video frames from a video stream. The video frames may include, for example, a first video frame and a second video frame. In some implementations, as represented by block 310g, a relative rotation of the electronic device between the first video frame and the second video frame may be determined based on the surface normal frequency data.

In various implementations, as represented by block 320, the method 300 includes determining surface normal frequency data based on the image data. For example, the image data may be analyzed to generate a histogram characterizing relative frequencies of normal vectors. Analyzing the surface normal vectors may facilitate estimating real-time relative camera rotation, as well as performing real-time deterministic surface detection. In some implementations, as represented by block 320a, at least one relative maximum may be identified based on the surface normal frequency data.

In some implementations, the normal frequency data may be determined by creating a histogram. For example, FIG. 1F illustrates an example image 120 that may be captured by the image sensor. As shown in FIG. 1F, the image 120 may be characterized by several curved surfaces. FIG. 1G illustrates an example image 122 with per pixel normal vectors corresponding to the image 120 extracted. As shown in FIG. 1G, in some implementations, the distribution of surface normal vectors may demonstrate relative maximums, e.g., peaks, at certain locations. For example, if the ground is visible in the image 122, a vector normal to the ground may be expected to fall within one of the normal distribution peaks.

A two-dimensional (2D) histogram may be created in spherical coordinates using a spherical coordinate transformation, e.g.,

$$\begin{matrix}θ = {cos}^{- 1} \frac{z}{\sqrt{{x}^{2} + {y}^{2} + {z}^{2}}} \\ ϕ = sgn ( y ) \cdot {cos}^{- 1} \frac{x}{\sqrt{{x}^{2} + {y}^{2}}}\end{matrix}$$

to transform unit vectors to an embedding space. In the embedded space, some features may become apparent. For example, even in an environment characterized by curvatures, dominant orientations may be visible. FIG. 1H illustrates an example 2D histogram 124 in spherical coordinates with relative maximums indicated. FIGS. 1I and 1J illustrate additional examples of images 128, 130; corresponding normal analyses 132, 134; and normal histograms 136, 138. Relative maximums in the embedded spaces may be aligned with surface orientations of major structures in the images 128, 130. Relative maximums in the normal histograms 136, 138 may be selected as tentative surface orientations. In some implementations, the video data may represent overlapping or successive video frames in a video stream, and the relative maximums may serve as landmarks to compute relative rotation of the electronic device between the frames. In some implementations, camera axis estimation in this way does not rely on external sensory data, such as from an inertial measurement unit (IMU). Accordingly, results of this approach to camera axis estimation may be accurate even if simultaneous localization and mapping (SLAM) fails to track the camera pose.

In some implementations, as represented by block 320b, the at least one relative maximum may be used to determine a candidate surface orientation. For example, in some implementations, as represented by block 320c, the method 300 may include determining a set of mutually orthogonal vectors that correspond to the electronic device based on the at least one relative maximum. The vectors may be normalized, as represented at block 320d, so that the vectors are unit vectors, e.g., with a length of one unit.

In various implementations, as represented by block 330, the method 300 includes determining an orientation of the electronic device in the physical environment based on the surface normal frequency data. For example, in some implementations, as represented by block 330a, the method 300 may include identifying a plane that is represented in the image data based on the surface normal frequency data. If the surface normal frequency data indicates that a region of the image represented by the image data corresponds to surface normal vectors that are aligned, for example, it may be inferred that a plane exists in the region and that the plane has a normal vector that is parallel to the surface normal vectors.

In some implementations, as represented by block 330b, the method 300 may include identifying a plane that is represented in a plurality of video frames that are represented in the image data. As represented by block 330c, the relative motion of the electronic device may be determined based on the identified plane represented in the plurality of video frames. For example, a change in the apparent position of the identified plane between a first video frame and a second video frame may be used to infer the motion of the electronic device.

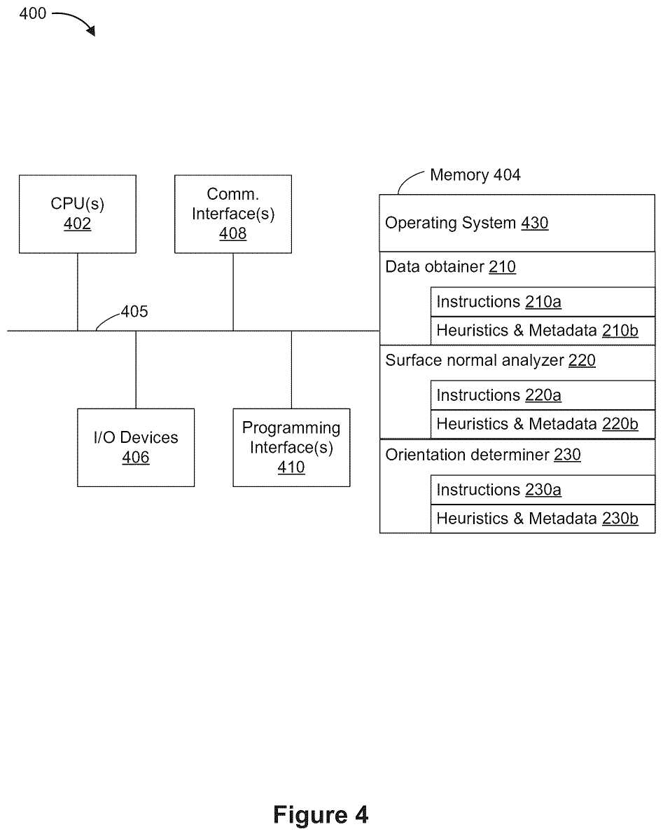

FIG. 4 is a block diagram of a device 400 in accordance with some implementations. In some implementations, the device 400 implements the electronic device 100 shown in FIGS. 1A-1B, and/or the orientation system 200 shown in FIGS. 1A-1B and 2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 402, a memory 404, one or more input/output (I/O) devices 406, one or more communication interfaces 408, one or more programming interfaces 410, and one or more communication buses 405 for interconnecting these and various other components.

In some implementations, the communication interface 408 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 402. The memory 404 comprises a non-transitory computer readable storage medium.

In some implementations, the memory 404 or the non-transitory computer readable storage medium of the memory 404 stores the following programs, modules and data structures, or a subset thereof including an optional operating system 430, the data obtainer 210, the surface normal analyzer 220, and the orientation determiner 230. In various implementations, the device 400 performs the method 300 shown in FIG. 3.

In some implementations, the data obtainer 210 includes instructions 210a and heuristics and metadata 210b for obtaining image data and/or depth information corresponding to the physical environment from the image sensor and/or from a depth sensor. In some implementations, the surface normal analyzer 220 determines surface normal frequency data based on the image data. To that end, the surface normal analyzer 220 includes instructions 220a and heuristics and metadata 220b.

In some implementations, the orientation determiner 230 determines an orientation of the electronic device in the physical environment based on the surface normal frequency data. To that end, the orientation determiner 230 includes instructions 230a and heuristics and metadata 230b.

In some implementations, the one or more I/O devices 406 include a user-facing image sensor (e.g., a front-facing camera) and/or a scene-facing image sensor (e.g., a rear-facing camera). In some implementations, the one or more I/O devices 406 include one or more head position sensors that sense the position and/or motion of the head of the user. In some implementations, the one or more I/O devices 406 include a display for displaying the graphical environment (e.g., for displaying the CGR environment 106 shown in FIG. 1A). In some implementations, the one or more I/O devices 406 include a speaker for outputting an audible signal.

In various implementations, the one or more I/O devices 406 include a video pass-through display which displays at least a portion of a physical environment surrounding the device 400 as an image captured by a scene camera. In various implementations, the one or more I/O devices 406 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at an electronic device including one or more processors, a non-transitory memory, and an image sensor:
obtaining image data corresponding to a physical environment from the image sensor;
determining surface normal frequency data based on the image data; and
determining an orientation of the electronic device in the physical environment based on the surface normal frequency data.

2. The method of claim 1, wherein the image data represents a still image.

3. The method of claim 1, wherein the image data represents a video frame from a video stream.

4. The method of claim 1, further comprising obtaining depth information from a depth sensor.

5. The method of claim 4, wherein the depth information comprises a depth map.

6. The method of claim 4, further comprising determining an orientation of the electronic device based in part on the depth data.

7. The method of claim 1, further comprising identifying at least one relative maximum based on the surface normal frequency data.

8. The method of claim 7, further comprising determining a candidate surface orientation based on the at least one relative maximum.

9. The method of claim 7, further comprising determining a set of mutually orthogonal vectors corresponding to the electronic device based on the at least one relative maximum.

10. The method of claim 9, further comprising normalizing the set of mutually orthogonal vectors.

11. The method of claim 10, further comprising determining a rotation matrix based on the normalized set of mutually orthogonal vectors.

12. The method of claim 11, further comprising adjusting the rotation matrix based on a cost function.

13. The method of claim 1, wherein the image data represents a plurality of video frames from a video stream comprising at least a first video frame and a second video frame.

14. The method of claim 13, further comprising determining a relative rotation of the electronic device between the first video frame and the second video frame based on the surface normal frequency data.

15. The method of claim 1, further comprising identifying a plane represented in the image data based on the surface normal frequency data.

16. The method of claim 1, further comprising identifying a plane represented in a plurality of video frames represented in the image data.

17. The method of claim 16, further comprising determining a relative motion of the electronic device based on the identified plane represented in the plurality of video frames.

18. The method of claim 1, wherein determining surface normal frequency data comprises generating a histogram characterizing relative frequencies of normal vectors.

19. An electronic device comprising:
one or more processors;
a non-transitory memory;
an image sensor; and
one or more programs stored in the non-transitory memory, which, when executed by the one or more processors, cause the device to:
obtain image data corresponding to a physical environment from the image sensor;
determine surface normal frequency data based on the image data; and
determine an orientation of the electronic device in the physical environment based on the surface normal frequency data.

20. A non-transitory memory storing one or more programs, which, when executed by one or more processors of an electronic device with an image sensor, cause the electronic device to:
obtain image data corresponding to a physical environment from the image sensor;
determine surface normal frequency data based on the image data; and
determine an orientation of the electronic device in the physical environment based on the surface normal frequency data.
